(19) United States
(12) Patent Application Publication
(10) Pub. No.: US 2025/0200246 A1
(43) Pub. Date: Jun. 19, 2025

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Daiki KIRIBUCHI, Ota (JP); Takufumi YOSHIDA, Funabashi (JP)

(73) Assignee: KABUSHIKI KAISHA TOSHIBA, Tokyo (JP)

(21) Appl. No.: 18/768,174

(22) Filed: Jul. 10, 2024

(30) Foreign Application Priority Data
Dec. 13, 2023 (JP) 2023-210309

(51) Int. Cl. G06F 30/20; G06F 119/02

(52) U.S. Cl. CPC G06F 30/20; G06F 2119/02

(57) ABSTRACT

According to an embodiment, an information processing device includes a hardware processor configured to: generate an estimation model based on one or more data sets each including one of n set values and one of one or more evaluation values representing evaluation of an experiment or a simulation performed by using the n set values, and change direction information; and calculate n recommended values to be recommended as the n set values used for the experiment or the simulation based on the estimation model. The change direction information indicates a direction of a change of a target evaluation value among the one or more evaluation values with respect to a change of a target parameter among n parameters corresponding to the n set values for any one or more of combinations each consisting of one of the n parameters and one of the one or more evaluation values.

### CROSS-REFERENCE TO RELATED APPLICATIONS

This application is based upon and claims the benefit of priority from Japanese Patent Application No. 2023-210309, filed on Dec. 13, 2023; the entire contents of which are incorporated herein by reference.

### FIELD

Embodiments described herein relate generally to an information processing device, an information processing method, and a computer program product.

### BACKGROUND

In various fields, optimization based on a simulation is practically used for improving a set value set for a system. For example, a set value set for a manufacturing system that manufactures products can be calculated by optimization based on a simulation. In this case, for example, an optimum set value is calculated by optimization processing that maximizes or minimizes an evaluation function for evaluating the system that manufactures the products.

There is also known constrained optimization based on a simulation. In the constrained optimization based on a simulation, an optimum set value is calculated by optimization processing that maximizes or minimizes the evaluation function under the condition that a constraint function representing a constraint on the system is from a predetermined lower limit threshold through a predetermined upper limit threshold, both inclusive. As such constrained optimization based on a simulation, there is known constrained Bayesian optimization.

In the constrained Bayesian optimization, processing is repeated such that a recommended set value is calculated, an evaluation value is calculated by performing an experiment or a simulation based on the recommended set value, an estimation model is generated based on a set of the recommended set value and the evaluation value, and a new recommended set value is calculated by the generated estimation model. Such constrained Bayesian optimization can reduce the number of times of simulation and improve computation efficiency if an accurate estimation model can be generated. However, it is very difficult to generate an accurate estimation model.

### BRIEF DESCRIPTION OF THE DRAWINGS

FIG. 1 is a diagram illustrating a configuration of an information processing system according to an embodiment;

FIG. 2 is a diagram illustrating an example of setting range information;

FIG. 3 is a diagram illustrating an example of data set information;

FIG. 4 is a diagram illustrating an example of change direction information;

FIG. 5 is a diagram illustrating a configuration of a processing unit together with a storage unit;

FIG. 6 is a flowchart illustrating a processing procedure of the information processing system; and

FIG. 7 is a diagram illustrating a hardware configuration of the information processing device.

### DETAILED DESCRIPTION

According to an embodiment, an information processing device includes a hardware processor configured to: generate an estimation model based on one or more data sets and change direction information, the one or more data sets each including corresponding one of n set values (n is an integral number equal to or larger than 1) and corresponding one of one or more evaluation values representing evaluation of an experiment or a simulation performed by using the n set values; and calculate n recommended values to be recommended as the n set values used for the experiment or the simulation based on the estimation model. The change direction information indicates a direction of a change of a target evaluation value among the one or more evaluation values with respect to a change of a target parameter among n parameters corresponding to the n set values for any one or more of combinations each consisting of corresponding one of the n parameters and corresponding one of the one or more evaluation values.

The following describes an embodiment of the present invention in detail with reference to the attached drawings.

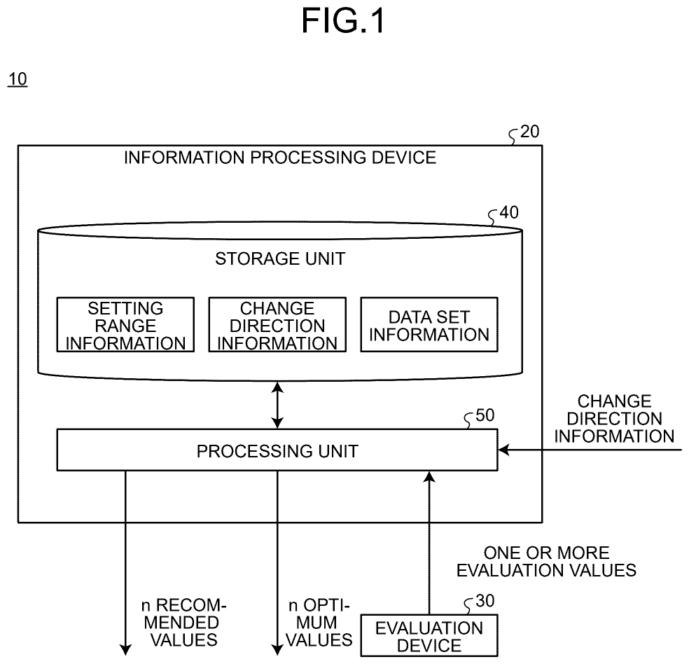

FIG. 1 is a diagram illustrating a configuration of an information processing system 10 according to the embodiment.

The information processing system 10 calculates and outputs n optimum set values used for manufacturing a product to improve productivity, a yield, and reliability of a manufacturing system that manufactures the product such as a semiconductor, for example. Note that n represents an integral number equal to or larger than 1.

The n set values are values input to the manufacturing system such as a machining time, a dimension, resistance, a voltage, and an electric charge, for example. The n set values are independent of each other, and are individual values. Each of the n set values may be any of a continuous value, a discrete value, and a logical value (category variable). That is, a type of each of the n set values is not particularly limited. For example, each of the n set values may represent a physical value such as a temperature and a pressure, or may represent a value related to an operation of the system such as a processing time and a processing condition.

An objective function is a function including n parameters, and a function for calculating an objective function value representing evaluation of the manufacturing system such as a quality characteristic, a fraction defective, a manufacturing time, and manufacturing cost of a product to be manufactured, for example. Each of the n parameters is a variable representing a set value input to the manufacturing system such as a machining time, a dimension, resistance, a voltage, and an electric charge. The n parameters correspond to the n set values on a one-to-one basis. The constraint function is a function including the n parameters to calculate a constraint function value representing a constraint on the manufacturing system.

In a case of not including the constraint function, the information processing system 10 calculates and outputs, as the n optimum set values, values of the n parameters that optimize (for example, minimize or maximize) the objective function value. In a case of including one or more constraint functions, the information processing system 10 calculates and outputs, as the n optimum set values, the values of the n parameters that optimize (for example, minimize or maximize) the objective function value under the condition that each of the one or more constraint function values is from an individually determined lower limit threshold through a predetermined upper limit threshold, both inclusive. In a case of including a plurality of the objective functions, the information processing system 10 calculates and outputs, as a plurality of sets of the n optimum set values, values of a plurality of sets of the n parameters with which the objective function values are non-inferior solutions. A user then sets the n optimum set values output from the information processing system 10 to the manufacturing system. Due to this, the manufacturing system can improve productivity, a yield, and reliability of a product such as a semiconductor, for example.

In the present embodiment, each of the objective function and the constraint function is referred to as an evaluation function. In the present embodiment, each of the objective function value and the constraint function value is referred to as an evaluation value.

The information processing system 10 may output n optimum set values to be set for any system, experiment, information processing, and the like instead of such a manufacturing system. For example, the information processing system 10 may output an optimum set value of each of n parameters used for a power generation plant, and an optimum set value of each of n hyperparameters used for machine learning.

The n optimum set values are n values that are assumed to be optimum by the information processing system 10 regardless of whether the values are actually optimum. The information processing system 10 may also calculate a plurality of sets of the n optimum set values.

In the present specification, the number of the n parameters may be referred to as the number of items or the number of dimensions of a model. In the present specification, for example, the n-th (n is an integral number equal to or larger than 2) parameter among the n parameters may be referred to as an n-dimensional parameter in some cases.

The information processing system 10 performs black box optimization to search for the n optimum set values by repeatedly calculating the n set values based on a result of an experiment or a simulation. The information processing system 10 performs the simulation by using a simulation model including the n parameters. The information processing system 10 repeatedly generates the n set values to be set for the n parameters included in the simulation model. The information processing system 10 may perform an experiment instead of the simulation, or may acquire a result of an experiment performed by the user and the like. In this case, the information processing system 10 may assume, for example, amounts of samples and the like used for the experiment to be the parameters, and output the n set values. Unless otherwise specifically noted in the following description, a term of “experiment” encompasses a simulation.

In the present embodiment, the information processing system 10 calculates and outputs the n optimum set values by using Bayesian optimization as an example of black box optimization. Specifically, in the present embodiment, the information processing system 10 uses a Gaussian process regression model that takes monotonicity into account as an estimation model that calculates estimation values and estimated standard deviations of one or more evaluation values based on the n parameters. The Gaussian process regression model that takes monotonicity into account is a Gaussian process regression model using information for identifying, for each of the n parameters, whether a target evaluation value of the one or more evaluation values monotonically increases as a target parameter increases, whether the target evaluation value monotonically decreases as the target parameter increases, or whether the target evaluation value does not monotonically increase or monotonically decrease with respect to the target parameter.

Such a Gaussian process regression model that takes monotonicity into account is disclosed in “Riihimaki, J., and Vehtari A., “Gaussian processes with monotonicity information”, March 2010, In Proceedings of the thirteenth international conference on artificial intelligence and statistics, pp. 645-652, JMLR Workshop and Conference Proceedings”. More details about the Gaussian process regression model that takes monotonicity into account will be described later.

The information processing system 10 includes an information processing device 20 and an evaluation device 30.

The information processing device 20 outputs n recommended values as n set values to be set as the n parameters used for an experiment.

The evaluation device 30 evaluates a result of the experiment based on the n recommended values output from the information processing device 20, and generates information about the evaluation. The information about the evaluation includes one or more evaluation values. Each of the one or more evaluation values represents evaluation of the result of the experiment performed by using the n recommended values output from the information processing device 20. The evaluation device 30 may perform a simulation based on the n recommended values, and generate the information about the evaluation based on an execution result of the simulation. In a case in which the user has performed an experiment based on the n recommended values, the evaluation device 30 may acquire a result of the experiment, and generate information about the evaluation based on the acquired result of the experiment.

The information processing device 20 also acquires the information about the evaluation from the evaluation device 30, and calculates the n recommended values again based on the acquired information about the evaluation. In other words, the information processing device 20 outputs the n recommended values used for the next experiment. In this way, the information processing system 10 calculates and outputs the n optimum set values after alternately repeating output of the n recommended values and the experiment so that an end condition determined in advance is reached. In the present embodiment, the n optimum set values may also be referred to as n optimum values.

In the example of FIG. 1, the information processing device 20 outputs the n set values to the outside, and acquires the information about the result of the experiment from the outside. However, the information processing device 20 may also include a simulator that performs a simulation. That is, the information processing device 20 may also serve as a simulator.

Herein, an evaluation function group {f(x)} on a set X⊂R^{D} is considered.

The evaluation function group {f(x)} is represented by the expression (1).

$$f ( x ) = \{ {f}_{1} ( {x}_{1} , … , {x}_{n} ) , {f}_{2} ( {x}_{1} , … , {x}_{n} ) , … , {f}_{m} ( {x}_{1} , … , {x}_{n} ) \} \qquad ( 1 )$$

m is an integral number equal to or larger than 1. Each of x₁, . . . , xₙ is a parameter. f₁(x₁, . . . , xₙ) is a first evaluation function for calculating a first evaluation value of the one or more evaluation values. f₂(x₁, . . . , xₙ) is a second evaluation function for calculating a second evaluation value of the one or more evaluation values. fₘ(x₁, . . . , xₙ) is an m-th evaluation function for calculating an m-th evaluation value of the one or more evaluation values.

In an optimization problem, the evaluation function group {f(x)} includes only the first evaluation function {f₁(x₁, . . . , xₙ)}. The optimization problem is a problem for calculating values of the n parameters (x₁, . . . , xₙ) that minimize or maximize f₁(x₁, . . . , xₙ).

In a constrained optimization problem, the evaluation function group {f(x)} includes two or more evaluation functions. The constrained optimization problem is a problem for calculating the values of the n parameters (x₁, . . . , xₙ) that minimize or maximize f₁(x₁, . . . , xₙ) under the condition that f₂(x₁, . . . , xₙ) is constrained to be a second lower limit threshold through a second upper limit threshold, both inclusive, f₃(x₁, . . . , xₙ) is constrained to be a third lower limit threshold through a third upper limit threshold, both inclusive, and fₘ(x₁, . . . , xₙ) is constrained to be an m-th lower limit threshold through an m-th upper limit threshold, both inclusive.

In a multi-objective optimization problem, the evaluation function group {f(x)} includes two or more evaluation functions. The multi-objective optimization problem is a problem for calculating Pareto solutions for f₁(x₁, . . . , xₙ), f=(x₁, . . . , xₙ), . . . , fₘ(x₁, . . . , xₙ).

The evaluation device 30 calculates the one or more evaluation values represented by the evaluation function group {f(x)} as described above. The information processing device 20 solves the optimization problem, the constrained optimization problem, or the multi-objective optimization problem represented by using the evaluation function group {f(x)} as described above.

The information processing device 20 includes a storage unit 40 and a processing unit 50.

The storage unit 40 is configured by any storage medium that is generally used such as a flash memory, a memory card, a random access memory (RAM), a hard disk drive (HDD), and an optical disc.

The storage unit 40 stores data used for processing performed by the information processing device 20. The storage unit 40 stores at least setting range information, data set information, and change direction information. The storage unit 40 may also store information other than the above information. For example, the storage unit 40 may store a processing result and the like of each of the constituent elements of the information processing device 20.

Before optimization processing, for example, the change direction information is input to the processing unit 50 by the user. In this case, the processing unit 50 causes the storage unit 40 to store the input change direction information before the optimization processing. The processing unit 50 may update the change direction information during the optimization processing. In this case, the processing unit 50 rewrites the change direction information stored in the storage unit 40 to updated change direction information. Alternatively, the change direction information may be input to the processing unit 50 by the user during the optimization processing. In this case, the processing unit 50 rewrites the change direction information stored in the storage unit 40 to the change direction information input by the user.

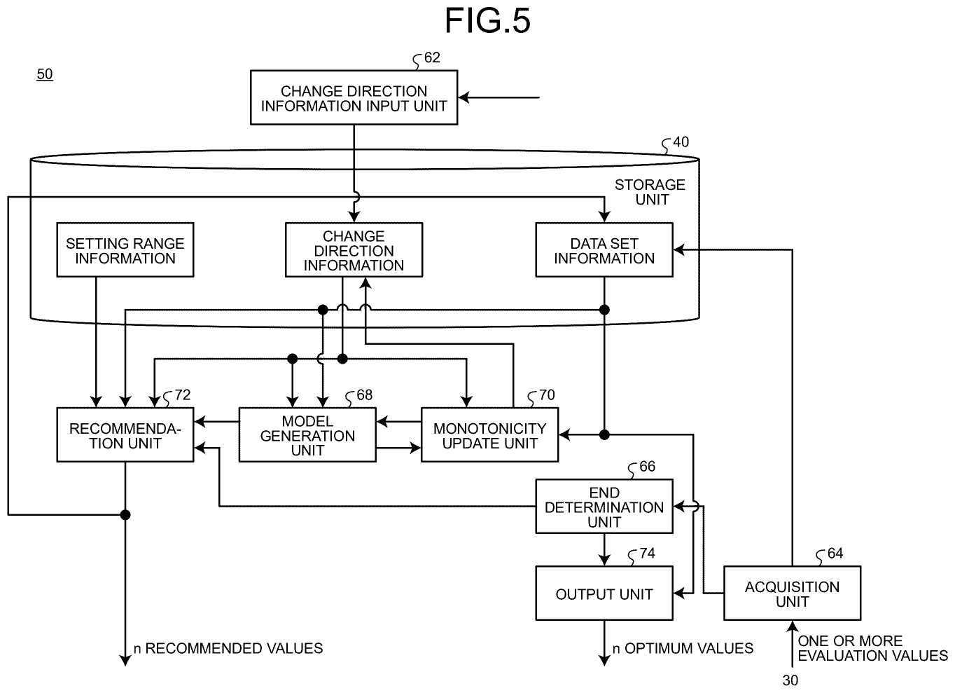

The processing unit 50 also repeatedly acquires the one or more evaluation values from the evaluation device 30 during the optimization processing. The processing unit 50 also repeatedly outputs the n recommended values during the optimization processing. The processing unit 50 then outputs the n optimum values at the end of the optimization processing. More details about the processing unit 50 will be described later with reference to FIG. 5.

The constituent elements illustrated in FIG. 1 are elements for performing processing of calculating and outputting the n recommended values and the n optimum values, and other constituent elements are not illustrated therein. The constituent elements may be subdivided or integrated with each other. For example, the storage unit 40 may be divided into a plurality of storage devices (for example, a plurality of storage media) depending on a file and the like to be stored therein. The number of the constituent elements other than the storage unit 40 may be assumed to be one. A processing result of each of the constituent elements may be transmitted to the constituent element by which the next processing is performed, or may be stored in the storage unit 40. In the latter case, the constituent element by which the next processing is performed accesses the storage unit 40 to acquire the processing result.

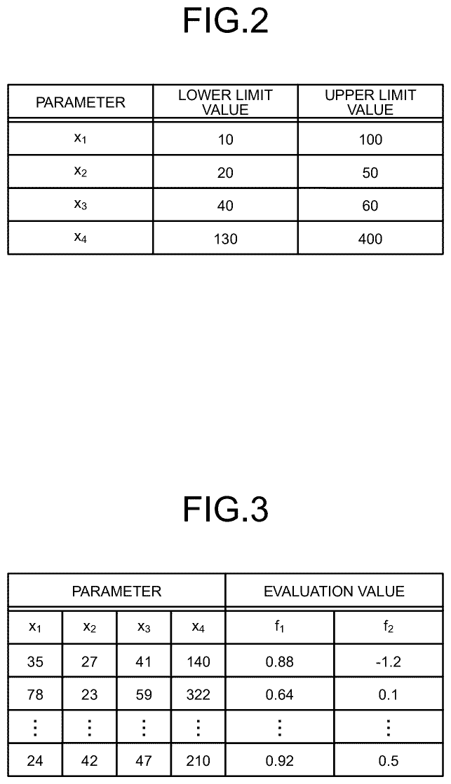

FIG. 2 is a diagram illustrating an example of the setting range information.

The setting range information includes a setting range for each of the n parameters. The setting range represents a range that may be taken by a set value to be set for a corresponding parameter. In other words, the setting range means a range of a value that can be set for a corresponding parameter, and is a search range in which a recommended value is searched for. The setting range information is, for example, input by the user and the like, and stored in the storage unit 40 in advance.

As illustrated in FIG. 2, for example, it is assumed that there are four parameters from x₁ to x₄. The setting range information represents a setting range for each of the parameters. The setting range is a range from a lower limit value through an upper limit value, both inclusive. For example, in the example of FIG. 2, a setting range for x₁ is a range from 10 through 100, both inclusive.

A method of representing the setting range is not particularly limited. For example, the setting range may be represented by using an inequality. For example, assuming that A is a matrix, B is a vector, and W is a parameter, the setting range may be represented as “AW+B<0 is satisfied”. Assuming that A is a vector, R is a real number, and W is a parameter, the setting range may be represented as “|W−A|<R is satisfied”. Herein, |W−A| represents magnitude of a vector “W−A”. Alternatively, the setting range may be represented by using inequalities including parameters in various formats.

FIG. 3 is a diagram illustrating an example of the data set information.

The data set information includes one or more data sets. Each of the one or more data sets includes the n set values and the one or more evaluation values. Each of the one or more evaluation values represents evaluation of an experiment performed by using the n set values included in the same data set. That is, one data set associates the n recommended values (n set values) output from the information processing device 20 with the one or more evaluation values obtained by evaluating the experiment performed by using the n recommended values (n set values).

FIG. 3 exemplifies a data set including four set values corresponding to the four parameters from x₁ to x₄ and two evaluation values corresponding to f₁ and f₂. In the example of FIG. 3, one row in a table represents one data set.

Every time the information processing device 20 acquires the one or more evaluation values from the evaluation device 30, a new data set including the one or more acquired evaluation values is added to the data set information. The new data set includes, as the n set values, the n recommended values used for the experiment as a base of the one or more included evaluation values.

The data set information may include a data set including test data generated in advance by the user, for example. That is, the data set information may include a data set including n set values that are not actually used for the experiment and the one or more evaluation values that are not generated by actually performing the experiment.

In a case in which the evaluation device 30 generates a plurality of the evaluation values, the data set may include a comprehensive evaluation value calculated based on the evaluation values. The data set may also include, as the evaluation value, output data for which the value can be calculated. The output data is, for example, data output from the evaluation device 30. The output data is constituted of a plurality of items similarly to the parameter. Each of the items represents an individual value. For example, the output data may be detection data of various sensors used for the experiment, or a physical characteristic value and a measurement value of an experiment result or a simulation result.

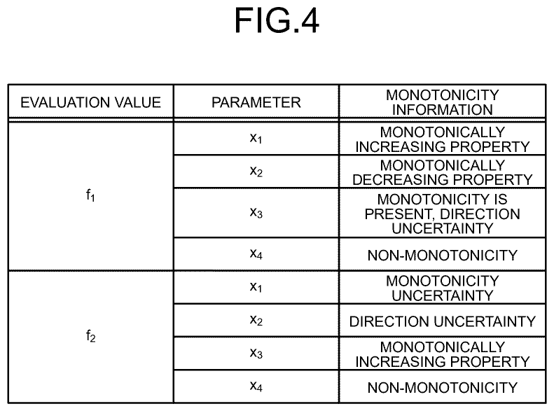

FIG. 4 is a diagram illustrating an example of the change direction information.

The change direction information indicates a direction of a change of a target evaluation value of the one or more evaluation values with respect to a change of a target parameter of the n parameters for any one or more of combinations each consisting of corresponding one of the n parameters and corresponding one of the one or more evaluation values. The change direction information may indicate a direction of a change of a target evaluation value of the one or more evaluation values with respect to a change of a target parameter of the n parameters for each of combinations each consisting of corresponding one of the n parameters and corresponding one of the one or more evaluation values.

The change direction information may indicate that a direction of a change of the target evaluation value with respect to a change of the target parameter may have no correlation for any one or more of combinations each consisting of corresponding one of the n parameters and corresponding one of the one or more evaluation values. The change direction information may indicate that the direction of the change is uncertain for any one or more of combinations each consisting of corresponding one of the n parameters and corresponding one of the one or more evaluation values.

In the present embodiment, as illustrated in FIG. 4, the change direction information includes monotonicity information for each combination of each of the n parameters and each of the one or more evaluation values.

The monotonicity information indicates any of a monotonically increasing property, monotonically decreasing property, non-monotonicity, direction uncertainty, and monotonicity uncertainty.

The monotonically increasing property represents that the target evaluation value monotonically increases as the target parameter increases. The monotonically decreasing property represents that the target evaluation value monotonically decreases as the target parameter increases. The non-monotonicity represents that neither monotonic increase nor monotonic decrease is caused. The direction uncertainty represents that monotonic increase or monotonic decrease is caused but it is uncertain which of the monotonic increase and the monotonic decrease is caused. The monotonicity uncertainty represents that it is uncertain which of the monotonically increasing property, the monotonically decreasing property, and the non-monotonicity is caused. The monotonicity uncertainty may represent that it is uncertain which of the monotonically increasing property, the monotonically decreasing property, the non-monotonicity, and the direction uncertainty is caused.

For example, the monotonic increase of the target evaluation value (f(x₁, . . . , xᵢ, . . . xₙ)) with respect to an i-dimensional target parameter (xᵢ) means that f(x₁, . . . , xᵢ, . . . xₙ)≤f(x₁, . . . , xᵢ′, . . . xₙ) is established in a case in which xᵢ<xᵢ′ is satisfied for an optional value in a range of a value that may be taken by each of parameters of all dimensions other than xᵢ. Additionally, the monotonic decrease of the target evaluation value (f(x₁, . . . , xᵢ, . . . xₙ)) with respect to the i-dimensional target parameter (xᵢ) means that f(x₁, . . . , xᵢ, . . . xₙ)≥f(x 1, . . . , xᵢ′, . . . xₙ) is established in a case in which xᵢ<xᵢ′ is satisfied for an optional value in a range of a value that may be taken by each of parameters of all dimensions other than xᵢ.

The non-monotonicity means that neither the monotonic increase nor the monotonic decrease of the target evaluation value (f(x₁, . . . , xᵢ, . . . xₙ)) is caused with respect to the i-dimensional target parameter (xᵢ).

The monotonic increase may mean that f(x₁, . . . , xᵢ, . . . xₙ)≤f(x₁, . . . , xᵢ′, . . . xₙ) is established in a case in which xᵢ<xᵢ′ is satisfied for part of the range of a value that may be taken, for example, for most of the values within the range, instead of an optional value within the range of a value that may be taken by each of the parameters of all dimensions other than xᵢ. Additionally, the monotonic decrease may mean that f(x₁, . . . , xᵢ, . . . xₙ)>f(x₁, . . . , xᵢ′, . . . x) is established in a case in which xᵢ<xᵢ′ is satisfied for part of the range of a value that may be taken, for example, for most of the values within the range, instead of an optional value within the range of a value that may be taken by each of the parameters of all dimensions other than xᵢ. That is, the monotonicity may be established in a broader sense than monotonicity used in mathematics. In this case, the non-monotonicity means that neither the monotonically increasing property in a broad sense nor the monotonically decreasing property in a broad sense is established.

For example, the change direction information illustrated in FIG. 4 indicates the monotonicity information for each combination in a case of using four-dimensional parameters of x₁, x₂, x₃, and x₄ and two evaluation values of f₁ and f₂.

For example, the monotonicity information in the second row of the table in FIG. 4 indicates that f₁ has the monotonically increasing property with respect to x₁. For example, the monotonicity information in the third row of the table in FIG. 4 indicates that f₁ has the monotonically decreasing property with respect to x₂. The monotonicity information in the fourth row of the table in FIG. 4 indicates that f₁ has the monotonicity with respect to x₃, but the direction is uncertain. The monotonicity information in the fifth row of the table in FIG. 4 indicates that f₁ has the non-monotonicity with respect to x₄.

The monotonicity information in the sixth row of the table in FIG. 4 indicates that the monotonicity of f₂ with respect to x₁ is uncertain. For example, the monotonicity information in the seventh row of the table in FIG. 4 indicates that the direction of f₂ with respect to x₂ is uncertain. The monotonicity information in the eighth row of the table in FIG. 4 indicates that f₂ has the monotonically increasing property with respect to x₃. The monotonicity information in the ninth row of the table in FIG. 4 indicates that f: has the non-monotonicity with respect to x₄.

FIG. 5 is a diagram illustrating a configuration of the processing unit 50 together with the storage unit 40.

The processing unit 50 includes a change direction information input unit 62, an acquisition unit 64, an end determination unit 66, a model generation unit 68, a monotonicity update unit 70, a recommendation unit 72, and an output unit 74.

The change direction information input unit 62 acquires the change direction information from the outside. For example, the change direction information input unit 62 acquires the change direction information input by the user. The change direction information input unit 62 causes the storage unit 40 to store the acquired change direction information. The change direction information input unit 62 may receive data in a format illustrated in FIG. 4, for example, or may receive data in a format different from the format illustrated in FIG. 4 and convert it into data in the format illustrated in FIG. 4 thereafter.

The change direction information input unit 62 may acquire the change direction information before the optimization processing, and does not necessarily acquire the change direction information thereafter. After acquiring the change direction information before the optimization processing, the change direction information input unit 62 may accept rewriting of part of the monotonicity information included in the change direction information in the middle of the optimization processing, and may rewrite the accepted content.

The acquisition unit 64 acquires, from the outside, an input of information required for processing performed by the information processing device 20. For example, the acquisition unit 64 acquires, from the evaluation device 30, the one or more evaluation values based on the n recommended values (n set values). In a case of acquiring the one or more evaluation values from the evaluation device 30, the acquisition unit 64 generates a new data set including the one or more acquired evaluation values. In this case, the new data set includes, as the n set values, the n recommended values used for the experiment as a base of the one or more included evaluation values. The acquisition unit 64 then adds the new data set to one or more data sets included in the data set information stored in the storage unit 40.

The acquisition unit 64 may further acquire the setting range information, information representing the end condition for determining whether to output the n optimum values, and the like before the optimization processing. In a case of acquiring the setting range information, the acquisition unit 64 causes the storage unit 40 to store the acquired setting range information. In a case of acquiring the information representing the end condition, the acquisition unit 64 gives the acquired information representing the end condition to the end determination unit 66.

The end determination unit 66 determines whether the end condition determined in advance is reached. The end condition is, for example, an execution frequency of the experiment, a setting time in which an elapsed time is determined in advance, or the like.

In a case in which the end condition is not reached, the end determination unit 66 gives an output instruction to the recommendation unit 72, for example, to cause the recommendation unit 72 to continuously output the n recommended values. In a case in which the end condition is reached, the end determination unit 66 gives an output stop instruction to the recommendation unit 72, for example, notifies the output unit 74 that the end condition is reached, and causes the output unit 74 to select the n optimum values (n optimum set values) based on a plurality of sets of the n recommended values (a plurality of sets of the n set values) that have been generated and output the selected n optimum values.

The model generation unit 68 generates an estimation model based on the change direction information and some or all of the one or more data sets included in the data set information. The model generation unit 68 generates the estimation model every time a new data set is added to the one or more data sets included in the data set information by the acquisition unit 64 during the optimization processing.

The estimation model is a model that calculates an estimation value and an estimated standard deviation for each of the one or more evaluation values based on the n parameters. In the present embodiment, the estimation model is represented by a numerical expression including the n parameters.

In the present embodiment, the model generation unit 68 generates the estimation model by using Gaussian process regression that takes monotonicity into account.

For example, in a case of outputting the n recommended values for the N-th time, the data set information includes (N−1) data sets that have been generated. In this case, the model generation unit 68 generates the estimation model by using the data set represented by the expression (2). N is an integral number equal to or larger than 2. k is an integral number equal to or larger than 1.

$${\{ {x}^{( k )} , {y}^{( k )} \}}_{k = 1}^{N - 1} \qquad ( 2 )$$

x^{(k)} is an array including the n set values generated in the k-th repetition processing. y^{(k)} is an array including the one or more evaluation values based on the n recommended values {x^{(k)}} generated in the k-th repetition processing.

Furthermore, in a case of generating the estimation model by using Gaussian process regression that takes monotonicity into account, the model generation unit 68 generates a data set of M pseudo partial differential values, and generates the estimation model based on the M pseudo partial differential values. M is an integral number equal to or larger than 1.

For example, in a case of outputting the n set values for the N-th time, the model generation unit 68 generates M pseudo data sets represented by the expression (3). j is an integral number equal to or larger than 1.

$${\{ {x}^{′ ( j )} , {y}_{d}^{{′}^{( j )}} \}}_{j = 1}^{M} \qquad ( 3 )$$

x′^{(j)} is an array including values having the same number of dimensions as the number of dimensions of the n parameters, which are values of n pseudo parameters included in the j-th pseudo data set of the M pseudo data sets.

y_{d}′^{(j)} is an array including an estimated partial differential value of any one of the one or more evaluation values corresponding to d-dimensional parameters included in the j-th pseudo data set of the M pseudo data sets. d is an integral number from 1 through n, both inclusive. For example, the model generation unit 68 sets y_{d}′^{(j)}=1 in a case in which the corresponding evaluation value monotonically increases with respect to the d-dimensional parameter, and sets y_{d}′^{(j)}=−1 in a case in which the corresponding evaluation value monotonically decreases with respect to the d-dimensional parameter.

The model generation unit 68 may generate the M pseudo data sets by using all of (N−1) x^{(k)}. The model generation unit 68 may select a portion of all (N−1) x^{(k)}, and generate the M pseudo data sets by using the selected portion. The model generation unit 68 may generate the M pseudo data sets by using a randomly selected portion of the parameters within a search range. The model generation unit 68 may generate grid points based on the search range, select all or a portion of the generated grid points, and generate the M pseudo data sets by using the selected portion. In a case of selecting part of all (N−1) x^{(k)}, the model generation unit 68 may randomly select parameter sets, or may select the parameter sets such that a D optimum standard of the selected part of the parameter sets is large.

After once generating the estimation model, the model generation unit 68 calculates the estimated partial differential value with a candidate for the pseudo parameter by using the generated estimation model. Subsequently, the model generation unit 68 determines that the parameter for which the monotonicity information indicates the monotonically increasing property is correctly estimated if the estimated partial differential value is positive. The model generation unit 68 also determines that the parameter for which the monotonicity information indicates the monotonically decreasing property is correctly estimated if the estimated partial differential value is negative. The model generation unit 68 may add, to the pseudo parameter, all or a portion of candidates for the pseudo parameter that has not been correctly estimated. Additionally, the model generation unit 68 may repeat generation of such an estimation model, determination, and addition of the pseudo parameter.

The model generation unit 68 may generate the M pseudo data sets by any method instead of the method described above.

For example, the model generation unit 68 generates a model represented by the expression (4) as a model that calculates an estimation value for an evaluation value (f).

$${μ}_{n}^{f} ( x ) = {μ}_{0}^{f} ( x ) + ( \begin{matrix}K ( x , X ) & K ( x , {X}^{′} )\end{matrix} ) {( ( \begin{matrix}K ( X , X ) & K ( X , {X}^{′} ) \\ K ( {X}^{′} , X ) & K ( {X}^{′} , {X}^{′} )\end{matrix} ) + ( \begin{matrix}{σ}^{2} I & 0 \\ 0 & \tilde{Σ}\end{matrix} ) )}^{- 1} ( ( \begin{matrix}y \\ \tilde{μ}\end{matrix} ) - m ) \qquad ( 4 )$$

The model generation unit 68 also generates a model represented by the expression (5) as a model that calculates the estimated standard deviation for the evaluation value (f).

$${{σ}_{n}^{f} ( x )}^{2} = K ( x , x ) - ( \begin{matrix}K ( x , X ) & K ( x , {X}^{′} )\end{matrix} ) {( ( \begin{matrix}K ( X , X ) & K ( X , {X}^{′} ) \\ K ( {X}^{′} , X ) & K ( {X}^{′} , {X}^{′} )\end{matrix} ) + ( \begin{matrix}{σ}^{2} I & 0 \\ 0 & \tilde{Σ}\end{matrix} ) )}^{- 1} ( \begin{matrix}K ( X , x ) \\ K ( {X}^{′} , x )\end{matrix} ) \qquad ( 5 )$$

The expression (4) and the expression (5) are expressions described in “Riihimaki, J., and Vehtari A., “Gaussian processes with monotonicity information”, March 2010, In Proceedings of the thirteenth international conference on artificial intelligence and statistics, pp. 645-652, JMLR Workshop and Conference Proceedings”. Constants and variables represented in the expression (4) and the expression (5) are described in “Riihimaki, J., and Vehtari A., “Gaussian processes with monotonicity information”, March 2010, In Proceedings of the thirteenth international conference on artificial intelligence and statistics, pp. 645-652, JMLR Workshop and Conference Proceedings”, and are as follows. μ₀^{f}(x) represents an optional function. X is a matrix in which x^{(k)} is arranged, and X′ is a matrix in which x′^{(j)} is arranged. y is a vector in which y^{(k)} is arranged. By using an optional kernel function k, K(X, X) is described as a matrix in which (i, j) components are k(x⁽ⁱ⁾, x^{(j)}). Similarly, for example, K(x, X) is a matrix in which (1, j) components are k(x, x^{(j)}). σ represents an optional real number, Σ^{˜} represents an optional diagonal matrix, and μ^{˜} represents an optional vector. Σ^{˜} is synonymous with a symbol obtained by adding ˜ to an upper side of Σ, and μ^{˜} is synonymous with a symbol obtained by adding ˜ to an upper side of μ. An average of y and μ^{˜} is represented as m.

The model generation unit 68 may generate the estimation model by using a method other than the Gaussian process regression that takes monotonicity into account.

In a case in which the number of the evaluation values is one, that is, in a case in which y^{(k)} is one dimensional, for example, the model generation unit 68 calculates an error between a square root of sum of squares of the evaluation value included in one or more data sets and the estimation value. The model generation unit 68 may then adjust a parameter included in the estimation model {μₙ^{f}(x₁, . . . , xₙ)} that calculates the estimation value of the evaluation value by a predetermined regression procedure such that the calculated square root of sum of squares is minimized.

The model generation unit 68 may use, as a predetermined regression procedure, for example, linear regression, Lasso regression, elastic net regression, random forest regression that takes monotonicity into account, a neural network that takes monotonicity into account, and the like. The model generation unit 68 may generate the estimation model {σₙ^{f}(x₁, . . . , xₙ)} that calculates the estimated standard deviation based on a regression result of the estimation model that calculates the estimation value of the evaluation value. For example, the model generation unit 68 may use a confidence interval of Bayesian linear regression, variance of outputs of a plurality of learned decision trees, and/or variance of outputs in a case of probabilistically performing dropout multiple times in a neural network as the estimation model that calculates the estimated standard deviation.

In a case in which the number of the evaluation values is multiple, that is, y^{(k)} has two or more dimensions, the model generation unit 68 generates, for example, the estimation model by using a method used in a case in which the number of the evaluation values is one for each of the evaluation values. That is, for f(x)={f₁(x₁, . . . , xₙ), f(x₁, . . . , xₙ), . . . , fₘ(x₁, . . . , xₙ)}, the model generation unit 68 repeats, m times, processing of calculating the estimation model {μₙ₁(x₁, . . . , xₙ)} that calculates the estimation value corresponding to f₁(x₁, . . . , xₙ) and the estimation model {σₙ₁(x₁, . . . , xₙ)} that calculates the estimated standard deviation, and calculating the estimation model {μₙ₂(x₁, . . . , xₙ)} that calculates the estimation value corresponding to f(x₁, . . . , xₙ) and the estimation model {σₙ₂(x₁, . . . , xₙ)} that calculates the estimated standard deviation. In a case in which the number of the evaluation values is multiple, the model generation unit 68 may calculate the estimation values and the estimated standard deviations for the evaluation values at the same time for the respective evaluation values by using a multi-output regression procedure.

The monotonicity update unit 70 updates the change direction information stored in the storage unit 40 as needed. The monotonicity update unit 70 may output the updated change direction information to the outside via the output unit 74.

For example, in a case in which the change direction information includes the monotonicity information indicating monotonicity uncertainty or direction uncertainty, the monotonicity update unit 70 updates the change direction information.

The monotonicity update unit 70 may calculate an estimation error, and update the change direction information in a case in which the calculated estimation error is larger than a threshold set in advance. The estimation error represents an error between the estimation values of the one or more evaluation values calculated based on the estimation model generated by the model generation unit 68 and the one or more evaluation values obtained by evaluating the experiment that has been performed by using the n recommended values generated by using this estimation model.

The monotonicity update unit 70 also acquires, from the model generation unit 68, the estimated partial differential value of each of the one or more evaluation values with respect to the parameter corresponding to the monotonicity information indicating monotonic increase or monotonic decrease in the change direction information. The estimated partial differential value is calculated by the model generation unit 68 based on the generated estimation model. The monotonicity update unit 70 may then update the change direction information in a case in which the monotonicity information indicating monotonic increase or monotonic decrease in the change direction information is different from the change direction specified by the estimated partial differential value for the corresponding parameter. For example, the monotonicity update unit 70 may update the change direction information in a case in which the estimated partial differential value of the corresponding parameter indicates a negative value for the monotonicity information indicating the monotonically increasing property. Additionally, for example, the monotonicity update unit 70 may update the change direction information in a case in which the estimated partial differential value of the corresponding parameter indicates a positive value for the monotonicity information indicating the monotonically decreasing property.

For example, the monotonicity update unit 70 updates the change direction information as follows in a case in which the change direction information includes the monotonicity information indicating monotonicity uncertainty or direction uncertainty.

The monotonicity update unit 70 generates a plurality of pieces of assumed change direction information corresponding to all combination patterns or a portion of the all combination patterns obtained by replacing all pieces of the monotonicity information indicating monotonicity uncertainty in the change direction information with the monotonically increasing property, the monotonically decreasing property, or the non-monotonicity, and replacing all pieces of the monotonicity information indicating direction uncertainty with the monotonically increasing property or the monotonically decreasing property. Subsequently, the monotonicity update unit 70 causes the model generation unit 68 to generate the estimation model for the pieces of assumed change direction information, and specifies the estimation model in which the estimation error is minimum, a length scale in learned Gaussian process regression is maximum, or the monotonicity information agrees with the change direction specified by the estimated partial differential value for the corresponding parameter. The monotonicity update unit 70 then updates the change direction information to be content of the assumed change direction information as a base of generation of the specified estimation model.

More specifically, for example, in a case in which the change direction information includes only one piece of the monotonicity information indicating monotonicity uncertainty, the monotonicity update unit 70 generates three patterns of assumed change direction information obtained by replacing the monotonicity information indicating monotonicity uncertainty with the monotonically increasing property, the monotonically decreasing property, or the non-monotonicity. In a case in which the change direction information includes two or more pieces of the monotonicity information indicating monotonicity uncertainty, the monotonicity update unit 70 generates a plurality of pieces of the assumed change direction information corresponding to all combination patterns or a portion of the all combination patterns obtained by replacing each of the two or more pieces of the monotonicity information indicating monotonicity uncertainty with the monotonically increasing property, the monotonically decreasing property, or non-monotonicity.

For example, in a case in which the change direction information includes only one piece of the monotonicity information indicating direction uncertainty, the monotonicity update unit 70 generates two patterns of the assumed change direction information obtained by replacing the monotonicity information indicating direction uncertainty with the monotonically increasing property or the monotonically decreasing property. In a case in which the change direction information includes two or more pieces of the monotonicity information indicating direction uncertainty, the monotonicity update unit 70 generates a plurality of pieces of the assumed change direction information corresponding to all combination patterns or a portion of the all combination patterns obtained by replacing each of the two or more pieces of the monotonicity information indicating direction uncertainty with the monotonically increasing property or the monotonically decreasing property.

In a case in which the change direction information includes any two or more pieces of the monotonicity information indicating monotonicity uncertainty and the monotonicity information indicating direction uncertainty, the monotonicity update unit 70 generates a plurality of pieces of the assumed change direction information corresponding to all combination patterns or a portion of the all combination patterns obtained by replacing the monotonicity information indicating monotonicity uncertainty with the monotonically increasing property, the monotonically decreasing property, or the non-monotonicity, and replacing the monotonicity information indicating direction uncertainty with the monotonically increasing property or the monotonically decreasing property.

In a case in which the change direction information does not include the monotonicity information indicating monotonicity uncertainty or direction uncertainty, the monotonicity update unit 70 selects one or more pieces of the monotonicity information indicating the monotonically increasing property or the monotonically decreasing property. In this case, for example, the monotonicity update unit 70 may select the monotonicity information indicating the monotonically increasing property or the monotonically decreasing property different from the change direction specified by the estimated partial differential value. The monotonicity update unit 70 generates one or more pieces of the assumed change direction information corresponding to all combination patterns or a portion of the all combination patterns obtained by replacing the monotonically increasing property with the monotonically decreasing property in each of the one or more selected pieces of monotonicity information. Among estimation models generated based on each of one or more pieces of the assumed change direction information and estimation models generated based on original change direction information, the monotonicity update unit 70 specifies the estimation model in which the estimation error is minimum, a length scale in learned Gaussian process regression is maximum, or the monotonicity information agrees with the change direction specified by the estimated partial differential value for the corresponding parameter. The monotonicity update unit 70 may then update the change direction information to be the content of the change direction information as a base of generation of the specified estimation model.

The recommendation unit 72 calculates and outputs the n recommended values recommended as the n set values used for the experiment based on the estimation model. The recommendation unit 72 calculates and outputs the n recommended values based on the generated estimation model every time the estimation model is generated by the model generation unit 68. The recommendation unit 72 continuously calculates and outputs the n recommended values every time the estimation model is generated until receiving the output stop instruction from the end determination unit 66, that is, until reaching the end condition set in advance.

The recommendation unit 72 as described above can determine, from a setting range, and output the n set values to be used for the next experiment. The recommendation unit 72 determines the next n recommended values by using black box optimization. In the present embodiment, the recommendation unit 72 determines the next n recommended values by using Bayesian optimization. The recommendation unit 72 may determine the next n recommended values by using a genetic algorithm, an evolutionary strategy, or CMA-ES.

For example, the recommendation unit 72 may calculate an acquisition function based on the estimation model that calculates the estimation values and the estimated standard deviation of the evaluation values, and may define parameters with which the acquisition function is maximum as the n recommended values to be output next. The recommendation unit 72 may use, as the acquisition function, Probability of Improvement (PI) or Expected Improvement (EI), for example. The recommendation unit 72 may use, as the acquisition function, Upper Confidence Bound (UCB), Thompson Sampling (TS), Entropy Search (ES), and Mutual Information (MI).

For example, in a case of UCB, the recommendation unit 72 calculates an (z) as the acquisition function as represented by the expression (6) using βₙ as an optional constant.

$${α}_{n} ( z ) = {μ}_{n} ( z ) + {β}_{n} {σ}_{n} ( z ) \qquad ( 6 )$$

For example, in a case of EI, the recommendation unit 72 calculates EIₙ(x) as the acquisition function as represented by the expression (7).

$${EI}_{n} ( x ) = {σ}_{n}^{f} ( x ) ( ( {Z}_{n} Φ ( {Z}_{n} ) + Φ ( {Z}_{n} ) ) \qquad ( 7 )$$

Zₙ in the expression (7) is represented by the expression (8).

$${Z}_{n} = \frac{{μ}_{n}^{f} ( x ) - {μ}_{n}^{f} ( {x}_{n}^{+} )}{{σ}_{n}^{f} ( x )} \qquad ( 8 )$$

φ in the expression (7) is a probability density function of standard normal distribution. xₙ⁺ in the expression (8) is the smallest parameter of the evaluation value at the present time.

The recommendation unit 72 may maximize the acquisition function by using an optional optimization method. For example, the recommendation unit 72 may maximize the acquisition function by using full search, random search, grid search, a gradient method, L-BFGS, DIRECT, CMA-ES, and a multi-start local improvement method.

In a case of the constrained optimization problem, the recommendation unit 72 obtains values (n recommended values) of the n parameters (x₁, . . . , xₙ) for which the evaluation function (f₁(x₁, . . . , xₙ)) as the objective function is minimum or maximum, and the other evaluation function {f₂(x₁, . . . , xₙ), . . . , fₘ(x₁, . . . , xₙ)} as the constraint function is from the lower limit threshold through the upper limit threshold, both inclusive. In this case, the recommendation unit 72 detects the n estimation values with which the objective function value is the best within a range in which the constraint function value satisfies the constraint. For example, the recommendation unit 72 may search for and output new n estimation values with which the object function value is estimated to be smaller than that of the previous n estimation values within the setting range. For example, the recommendation unit 72 can find a value with which the evaluation value of the objective function is smaller by using various optimization methods such as full search, random search, grid search, a gradient method, L-BFGS, DIRECT, CMA-ES, and a multi-start local improvement method.

The recommendation unit 72 may also determine the n recommended values to be output based on a product of the acquisition function and a constraint satisfaction rate based on the estimation value and the estimated standard deviation of the evaluation value. For example, assuming that the estimation value of the constraint function is μₙ^{c}(x) and the estimated standard deviation is σₙ^{c}(x), the recommendation unit 72 calculates the constraint satisfaction rate PFₙ(x) satisfying the constraint in which the constraint function is equal to or smaller than 0 as represented by the expression (9).

$${PF}_{n} ( x ) = Φ ( \frac{- {μ}_{n}^{c} ( x )}{{σ}_{n}^{c} ( x )} ) \qquad ( 9 )$$

In the expression (9), Φ represents a cumulative distribution function of standard normal distribution. For example, the recommendation unit 72 calculates a product of EIₙ(x) and PFₙ(x) as the acquisition function {EICₙ(x)=EIₙ(x)×PFₙ(x)}. The recommendation unit 72 then calculates a point x^{˜}ₙ at which the acquisition function is maximum by the expression (10). x^{˜} is synonymous with a symbol obtained by adding ˜ to an upper side of x in the expression (10).

$${\tilde{X}}_{n} = arg {max}_{x ∈ 𝒳} {EIC}_{n} ( x ) \qquad ( 10 )$$

The recommendation unit 72 may fix one or more set values of the n recommended values to the best set values at the present time, and determine the n recommended values to be output next. That is, the recommendation unit 72 sets the selected one or more set values among the n recommended values to the best values at the present time, and optimizes the remaining recommended values that are not selected by using the method described above.

For example, the recommendation unit 72 selects all or a portion of the parameters for which the monotonicity information is not uncertain to fix the selected parameters to the best values. The recommendation unit 72 may randomly select a portion of the parameters for which the monotonicity information is not uncertain to fix the selected parameters to the best values. Due to this, the recommendation unit 72 can optimize the set value corresponding to the parameter for which the monotonicity information is incorrect or the parameter for which the monotonicity information is monotonicity uncertainty or direction uncertainty, that is, the parameter as a cause of increasing the estimated standard deviation, and efficiently determine the n recommended values to be output next.

The recommendation unit 72 determines a plurality of next output values assuming that the data set information includes at least one data set. However, for example, in a case in which the user performs an experiment for the first time, there is a situation in which the data set information does not include any data set. Even in such a situation, the user may desire to perform the experiment by using the n recommended values output from the information processing device 20 in some cases. In such a case, the recommendation unit 72 may select, from a plurality of values determined in advance, initial n recommended values to be output. The recommendation unit 72 may output initial n recommended values that are determined in accordance with a rule determined in advance. The rule determined in advance is, for example, a rule for determining a plurality of values using any of a random number, a Latin square, and a Sobol sequence.

In a case in which the end determination unit 66 determines that the end condition is reached, the output unit 74 selects the n optimum values (n optimum set values) based on the n set values that have been output included in the data set information stored in the storage unit 40.

For example, the output unit 74 selects, as the n optimum values, a set of the n set values with which the evaluation value is minimum or maximum from among a plurality of sets of the n set values that have been output included in the data set information stored in the storage unit 40. The output unit 74 may select, as a set of the n optimum values, a set of non-inferior solutions among a plurality of sets of the n set values that have been output included in the data set information stored in the storage unit 40. The output unit 74 may also select, as the n optimum values, the n set values with which the evaluation value corresponding to the constraint function value is from the lower limit threshold through the upper limit threshold, both inclusive, and the evaluation value corresponding to the objective function value is minimum or maximum from among a plurality of sets of the n set values that have been output included in the data set information stored in the storage unit 40. The output unit 74 outputs the selected n optimum values.

The output unit 74 also outputs a processing result of each constituent element. For example, the output unit 74 may output the n recommended values to be output. The output unit 74 may receive an instruction via the acquisition unit 64, and output data stored in the storage unit 40 such as the data set information.

An output format of the output unit 74 is not particularly limited, and may be a table or an image, for example. For example, the output unit 74 may generate and output a graph based on data such as the data set information.

In a case in which the information processing device 20 includes a simulator, the simulator sets the n recommended values to the parameters of the model to execute a simulation, and calculates the one or more evaluation values based on a simulation result. In this case, an expression for calculating the one or more evaluation values is determined in advance.

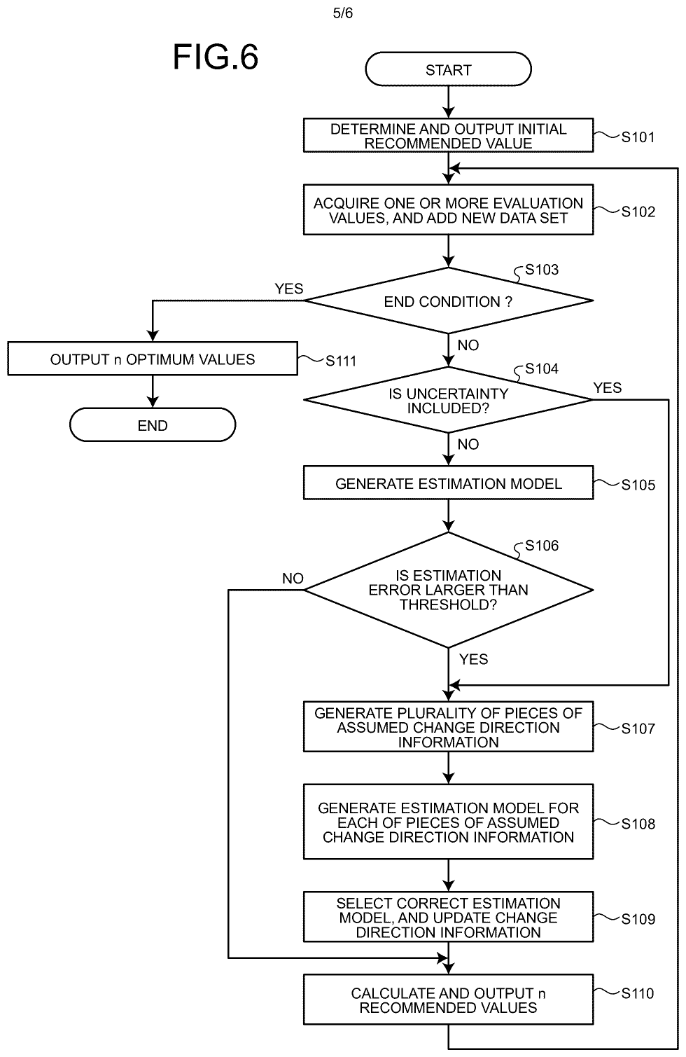

FIG. 6 is a flowchart illustrating a processing procedure of the information processing device 20 according to the embodiment. The information processing device 20 performs the processing by using the procedure illustrated in FIG. 6.

First, at S101, the recommendation unit 72 determines the initial n recommended values (n set values). For example, the recommendation unit 72 may select, from among a plurality of values determined in advance, the initial n recommended values to be output. The recommendation unit 72 may output the initial n recommended values that are determined in accordance with a rule determined in advance. The recommendation unit 72 then outputs the determined initial n recommended values.

In a case in which the n recommended values are output, for example, the user performs an experiment by using the output n recommended values. The evaluation device 30 acquires a result of the experiment, and generates the one or more evaluation values representing evaluation for the experiment with the n recommended values. Alternatively, a simulator executed by the evaluation device 30 or the information processing device 20 executes a simulation based on the output n recommended values. The simulator generates the one or more evaluation values representing evaluation of the simulation based on a result of the simulation. The evaluation device 30 may acquire a result of the simulation from the simulator, and generate the one or more evaluation values representing evaluation of the simulation instead of the simulator.

Subsequently, at S102, the acquisition unit 64 acquires the one or more evaluation values generated by the evaluation device 30 or the simulator. The acquisition unit 64 generates a new data set including the acquired one or more evaluation values, and adds the generated new data set to the data set information stored in the storage unit 40. In this case, the acquisition unit 64 includes the n recommended values used for the experiment with the acquired one or more evaluation values in the new data set as the n set values.

Subsequently, at S103, the end determination unit 66 determines whether the end condition determined in advance is reached. If the end determination unit 66 determines that the end condition is reached (Yes at S103), the process is advanced to S111. If the end determination unit 66 determines that the end condition is not reached (No at S103), the process is advanced to S104.

At S104, the monotonicity update unit 70 determines whether the change direction information stored in the storage unit 40 includes the monotonicity information indicating monotonicity uncertainty or the monotonicity information indicating direction uncertainty. If it is included (Yes at S104), the monotonicity update unit 70 advances the process to S107. If it is not included (No at S104), the monotonicity update unit 70 advances the process to S105.

At S105, based on the change direction information and some or all of the one or more data sets included in the data set information, the model generation unit 68 generates the estimation model that calculates the estimation value and the estimated standard deviation for each of the one or more evaluation values based on the n parameters.

Subsequently, at S106, the monotonicity update unit 70 calculates an estimation error of the estimation model, and determines whether the calculated estimation error is larger than a threshold determined in advance. If the estimation error is larger than the threshold (Yes at S106), the monotonicity update unit 70 advances the process to S107. If the estimation error is not larger than the threshold (No at S106), the monotonicity update unit 70 advances the process to S110. At S106, the monotonicity update unit 70 may determine whether the monotonicity information indicating monotonic increase or monotonic decrease in the change direction information is different from the change direction specified by the estimated partial differential value for the corresponding parameter. If they are different from each other, the monotonicity update unit 70 advances the process to S107, and if they are not different from each other, the monotonicity update unit 70 advances the process to S110.

At S107, the monotonicity update unit 70 generates a plurality of pieces of the assumed change direction information based on the change direction information stored in the storage unit 40. For example, the monotonicity update unit 70 generates a plurality of pieces of the assumed change direction information corresponding to all combination patterns or a portion of the all combination patterns obtained by replacing all pieces of the monotonicity information indicating monotonicity uncertainty in the change direction information with the monotonically increasing property, the monotonically decreasing property, or the non-monotonicity, and replacing all pieces of the monotonicity information indicating direction uncertainty with the monotonically increasing property or the monotonically decreasing property. Alternatively, the monotonicity update unit 70 selects one or more pieces of the monotonicity information indicating the monotonically increasing property or the monotonically decreasing property in the change direction information, and generates a plurality of pieces of the assumed change direction information corresponding to all combination patterns or a portion of the all combination patterns obtained by replacing each of the selected pieces of monotonicity information with a different one of the monotonically increasing property and the monotonically decreasing property.

Subsequently, at S108, the monotonicity update unit 70, the model generation unit 68 generates the estimation model for each of the pieces of assumed change direction information.

Subsequently, at S109, the monotonicity update unit 70 selects, as a correct estimation model, one estimation model among the estimation models for the respective pieces of assumed change direction information. For example, the monotonicity update unit 70 specifies, as the correct estimation model, the estimation model in which the estimation error is minimum, a length scale in learned Gaussian process regression is maximum, or the monotonicity information agrees with the change direction specified by the estimated partial differential value for the corresponding parameter. The monotonicity update unit 70 updates the change direction information stored in the storage unit 40 to be the content of the assumed change direction information used for generating the correct estimation model. When the monotonicity update unit 70 ends the process at S109, the process is advanced to S110.

At S110, the recommendation unit 72 calculates and outputs the n recommended values recommended as the n set values used for the experiment based on the estimation model. For example, the recommendation unit 72 may define a product of the constraint satisfaction probability and expected improvement as the acquisition function, and may define values with which the acquisition function is maximum as the n recommended values to be output next. In a case in which the change direction information is updated at S109, the recommendation unit 72 calculates the n recommended values based on the estimation model selected to be correct. After outputting the n recommended values, the recommendation unit 72 returns the process to S102.

At S111, from a plurality of sets of the n set values that have been output included in the data set information stored in the storage unit 40, the output unit 74 selects and outputs the n optimum values. After ending the process at S111, the information processing device 20 ends this procedure.

As described above, the information processing device 20 according to the present embodiment generates the estimation model based on the change direction information and one or more data sets each including the n set values and the one or more evaluation values, and calculates the n recommended values based on the estimation model. Furthermore, the information processing device 20 according to the present embodiment repeats processing of acquiring the one or more evaluation values representing evaluation of the experiment or the simulation using the calculated n recommended values, adding a new data set to one or more data sets, generating the estimation model based on the change direction information and the one or more data sets to which the new data set is added, and calculating the next n recommended values based on the estimation model. After repeating the processing until the end condition determined in advance is reached, the information processing device 20 according to the present embodiment outputs the n optimum values based on the one or more data sets. Due to this, the information processing device 20 according to the present embodiment can output, as the n optimum values, the n set values with which the evaluation values are good.

Furthermore, the information processing device 20 according to the present embodiment calculates the n estimation values by using the estimation model that takes monotonicity into account, so that the n optimum values can be output with a smaller number of repetitions. The information processing device 20 according to the present embodiment can check whether optimization is correctly performed by using the change direction information, and can update the change direction information to perform the optimization correctly in a case in which the optimization is not correctly performed.

In this way, with the information processing device 20 according to the present embodiment, an accurate estimation model can be generated, and the n set values can be efficiently optimized.

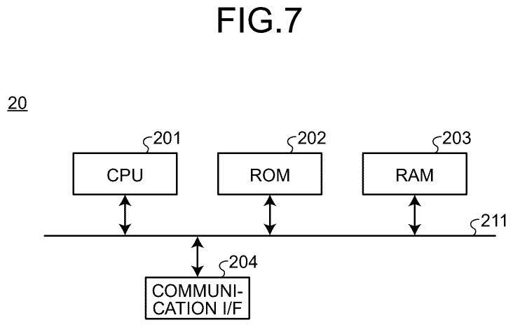

FIG. 7 is a diagram illustrating a hardware configuration example of the information processing device 20 according to the embodiment.

The information processing device 20 according to the embodiment includes a control device such as a CPU 201, a storage device such as a read only memory (ROM) 202 and a RAM 203, a communication I/F 204 that is connected to a network to perform communication, and a bus 211 that connects the respective components.

A computer program executed by the information processing device 20 according to the embodiment is embedded and provided in the ROM 202 and the like.

The computer program executed by the information processing device 20 according to the embodiment may be recorded in a computer-readable recording medium such as a compact disc read only memory (CD-ROM), a flexible disk (FD), a compact disc recordable (CD-R), and a digital versatile disc (DVD), as an installable or executable file to be provided as a computer program product.

Such a computer program executed by the information processing device 20 includes, for example, a change direction information input module, an acquisition module, an end determination module, a model generation module, a monotonicity update module, a recommendation module, and an output module.

This computer program is loaded into the RAM 203 by the CPU 201 (processor) and executed to cause a computer to function as the change direction information input unit 62, the acquisition unit 64, the end determination unit 66, the model generation unit 68, the monotonicity update unit 70, the recommendation unit 72, and the output unit 74. Some or all of the change direction information input unit 62, the acquisition unit 64, the end determination unit 66, the model generation unit 68, the monotonicity update unit 70, the recommendation unit 72, and the output unit 74 may be configured as a hardware circuit. The RAM 203 functions as the storage unit 40.

The computer program executed by the computer is recorded and provided in a computer-readable recording medium such as a CD-ROM, a flexible disk, a CD-R, and a digital versatile disk (DVD), as a file in a format that is installable in a computer or an executable format.

Furthermore, this computer program may be stored in a computer connected to a network such as the Internet and provided by being downloaded via the network. Furthermore, this computer program may be provided or distributed via a network such as the Internet. The computer program may be embedded and provided in the ROM 202 and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Notes

The embodiments described above can be summarized as the following Technical Ideas.

### Technical Idea 1

An information processing device including:
a processing unit configured to:
   generate an estimation model based on one or more data sets and change direction information, the one or more data sets each including corresponding one of n set values (n is an integral number equal to or larger than 1) and corresponding one of one or more evaluation values representing evaluation of an experiment or a simulation performed by using the n set values; and
   calculate n recommended values to be recommended as the n set values used for the experiment or the simulation based on the estimation model, wherein
the change direction information indicates a direction of a change of a target evaluation value among the one or more evaluation values with respect to a change of a target parameter among n parameters corresponding to the n set values for any one or more of combinations each consisting of corresponding one of the n parameters and corresponding one of the one or more evaluation values.

### Technical Idea 2

The information processing device according to Technical Idea 1, wherein
the estimation model is a model configured to calculate an estimation value and an estimated standard deviation for each of the one or more evaluation values, based on the n parameters corresponding to the n set values, and
each of the n parameters is a variable to which a corresponding set value among the n set values is input.

### Technical Idea 3

The information processing device according to Technical Idea 1 or 2, wherein the change direction information indicates a direction of a change of the target evaluation value with respect to a change of the target parameter for each of the combinations each consisting of corresponding one of the n parameters and corresponding one of the one or more evaluation values.

### Technical Idea 4

The information processing device according to Technical Idea 2 or 3, wherein
the processing unit is configured to repeat processing of:
   acquiring the one or more evaluation values representing evaluation of the experiment or the simulation using the n recommended values every time the n recommended values are calculated;
   adding a new data set including the acquired one or more evaluation values to the one or more data sets every time the one or more evaluation values are acquired, the new data set including the n recommended values as the n set values;
   generating the estimation model every time the new data set is added to the one or more data sets; and
   calculating the n recommended values based on the generated estimation model every time the estimation model is generated.

### Technical Idea 5

The information processing device according to Technical Idea 4, wherein the processing unit is configured to output the n recommended values selected from a plurality of values determined in advance or the n recommended values generated based on a rule determined in advance in a case in which the one or more data sets are not present.

### Technical Idea 6

The information processing device according to Technical Idea 5, wherein the processing unit is configured to output the n set values included in a data set with which the one or more evaluation values are best among the one or more data sets after repeating the processing until an end condition determined in advance is reached.

### Technical Idea 7

The information processing device according to any one of Technical Idea 2 to 6, wherein the estimation model is a model that takes monotonicity into account using information for identifying, for each of the n parameters, whether the target evaluation value of the one or more evaluation values monotonically increases as the target parameter increases, the target evaluation value monotonically decreases as the target parameter increases, or the target evaluation value does not monotonically increase or monotonically decrease with respect to the target parameter.

### Technical Idea 8

The information processing device according to Technical Idea 7, wherein the estimation model is a Gaussian process regression model that takes monotonicity into account, and the estimation value is represented by an expression (101), and the estimated standard deviation is represented by an expression (102).

$${μ}_{n}^{f} ( x ) = {μ}_{0}^{f} ( x ) + ( \begin{matrix}K ( x , X ) & K ( x , {X}^{′} )\end{matrix} ) {( ( \begin{matrix}K ( X , X ) & K ( X , {X}^{′} ) \\ K ( {X}^{′} , X ) & K ( {X}^{′} , {X}^{′} )\end{matrix} ) + ( \begin{matrix}{σ}^{2} I & 0 \\ 0 & \tilde{Σ}\end{matrix} ) )}^{- 1} ( ( \begin{matrix}y \\ \tilde{μ}\end{matrix} ) - m ) \qquad ( 101 )$$

$${{σ}_{n}^{f} ( x )}^{2} = K ( x , x ) - ( \begin{matrix}K ( x , X ) & K ( x , {X}^{′} )\end{matrix} ) {( ( \begin{matrix}K ( X , X ) & K ( X , {X}^{′} ) \\ K ( {X}^{′} , X ) & K ( {X}^{′} , {X}^{′} )\end{matrix} ) + ( \begin{matrix}{σ}^{2} I & 0 \\ 0 & \tilde{Σ}\end{matrix} ) )}^{- 1} ( \begin{matrix}K ( X , x ) \\ K ( {X}^{′} , x )\end{matrix} ) \qquad ( 102 )$$

### Technical Idea 9

The information processing device according to Technical Idea 7 or 8, wherein the processing unit is configured to generate the estimation model by further using one or more pseudo data sets each including corresponding one of n values corresponding to n pseudo parameters and corresponding one of estimated partial differential values of the one or more evaluation values with respect to a d-dimensional parameter (d is from 1 through n, both inclusive) among the n parameters.

### Technical Idea 10

The information processing device according to any one of Technical Ideas 7 to 9, wherein
the change direction information includes monotonicity information for each of the combinations each consisting of corresponding one of the n parameters and corresponding one of the one or more evaluation values, and
the monotonicity information indicates any of:
   a monotonically increasing property representing that the target evaluation value monotonically increases as the target parameter increases;
   a monotonically decreasing property representing that the target evaluation value monotonically decreases as the target parameter increases;
   non-monotonicity representing that the target evaluation value does not monotonically increase or monotonically decrease with respect to the target parameter;
   direction uncertainty representing that the target evaluation value monotonically increases or monotonically decreases with respect to the target parameter but it is uncertain which of monotonic increase and monotonic decrease is caused; and
   monotonicity uncertainty representing that it is uncertain which of the monotonically increasing property, the monotonically decreasing property, and the non-monotonicity with respect to the target parameter the target evaluation value has.

### Technical Idea 11

The information processing device according to Technical Idea 10, wherein
the processing unit is configured to:
   in a case in which the change direction information includes the monotonicity information indicating the monotonicity uncertainty or the direction uncertainty,
      generate a plurality of pieces of assumed change direction information corresponding to all combination patterns or a portion of the all combination patterns obtained by replacing all pieces of the monotonicity information indicating the monotonicity uncertainty in the change direction information with the monotonically increasing property, the monotonically decreasing property, or the non-monotonicity, and replacing all pieces of the monotonicity information indicating the direction uncertainty with the monotonically increasing property or the monotonically decreasing property,
      generate, for each of the plurality of pieces of assumed change direction information, the estimation model based on a corresponding piece of the assumed change direction information and the one or more data sets,
      select an estimation model in which an estimation error is minimum or a length scale is maximum from among the estimation models each generated for corresponding one of the plurality of pieces of assumed change direction information, and
      calculate the n recommended values based on the selected estimation model.

### Technical Idea 12

The information processing device according to Technical Idea 11, wherein the processing unit is configured to update the change direction information to be the assumed change direction information used for generating the selected estimation model.

### Technical Idea 13

The information processing device according to Technical Idea 12, wherein the processing unit is configured to update the change direction information in a case in which an estimation error is larger than a threshold determined in advance.

### Technical Idea 14

The information processing device according to Technical Idea 12 or 13, wherein
the processing unit is configured to:
   calculate an estimated partial differential value for each of the one or more evaluation values with respect to a parameter corresponding to the monotonicity information indicating the monotonic increase or the monotonic decrease in the change direction information, based on the estimation model; and
   update the change direction information in a case in which the monotonicity information indicating the monotonic increase or the monotonic decrease in the change direction information is different from a change direction of each of the one or more evaluation values identified by the estimated partial differential value for the corresponding parameter.

### Technical Idea 15

The information processing device according to any one of Technical Ideas 10 to 14, wherein the processing unit is configured to calculate the n recommended values based on the estimation model by using Bayesian optimization.

### Technical Idea 16

The information processing device according to Technical Idea 15, wherein the processing unit is configured to calculate the n recommended values that maximize a product of expected improvement and constraint satisfaction probability in the Bayesian optimization.

### Technical Idea 17

The information processing device according to Technical Idea 15 or 16, wherein
the processing unit is configured to:
   select a best data set with which the one or more evaluation values are best from among the one or more data sets;
   select a portion of the n parameters of the estimation model; and
   fix values of the selected portion of the n parameters to corresponding values of the n set values included in the best data set, and calculate the n recommended values based on the estimation model.

### Technical Idea 18

The information processing device according to Technical Idea 17, wherein
the processing unit is configured to:
   select the portion of the n parameters with which the monotonicity information does not indicate the monotonicity uncertainty or the direction uncertainty; and
   fix values of the selected portion of the n parameters to corresponding values of the n set values included in the best data set, and calculate the n recommended values with which an acquisition function is maximum, based on the estimation model.

### Technical Idea 19

An information processing method including:
generating, by an information processing device, an estimation model based on one or more data sets and change direction information, the one or more data sets each including corresponding one of n set values (n is an integral number equal to or larger than 1) and corresponding one of one or more evaluation values representing evaluation of an experiment or a simulation performed by using the n set values; and
calculating, by the information processing device, n recommended values to be recommended as the n set values used for the experiment or the simulation based on the estimation model, wherein
the change direction information indicates a direction of a change of a target evaluation value among the one or more evaluation values with respect to a change of a target parameter among n parameters corresponding to the n set values for any one or more of combinations each consisting of corresponding one of the n parameters and corresponding one of the one or more evaluation values.

### Technical Idea 20

A computer program for causing an information processing device to function as a processing unit configured to:
generate an estimation model based on one or more data sets and change direction information, the one or more data sets each including corresponding one of n set values (n is an integral number equal to or larger than 1) and corresponding one of one or more evaluation values representing evaluation of an experiment or a simulation performed by using the n set values; and
calculate n recommended values to be recommended as the n set values used for the experiment or the simulation based on the estimation model, wherein
the change direction information indicates a direction of a change of a target evaluation value among the one or more evaluation values with respect to a change of a target parameter among n parameters corresponding to the n set values for any one or more of combinations each consisting of corresponding one of the n parameters and corresponding one of the one or more evaluation values.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a hardware processor configured to:
generate an estimation model based on one or more data sets and change direction information, the one or more data sets each including corresponding one of n set values (n is an integral number equal to or larger than 1) and corresponding one of one or more evaluation values representing evaluation of an experiment or a simulation performed by using the n set values; and
calculate n recommended values to be recommended as the n set values used for the experiment or the simulation based on the estimation model, wherein
the change direction information indicates a direction of a change of a target evaluation value among the one or more evaluation values with respect to a change of a target parameter among n parameters corresponding to the n set values for any one or more of combinations each consisting of corresponding one of the n parameters and corresponding one of the one or more evaluation values.

2. The device according to claim 1, wherein
the estimation model is a model configured to calculate an estimation value and an estimated standard deviation for each of the one or more evaluation values, based on the n parameters corresponding to the n set values, and
each of the n parameters is a variable to which a corresponding set value among the n set values is input.

3. The device according to claim 1, wherein the change direction information indicates a direction of a change of the target evaluation value with respect to a change of the target parameter for each of the combinations each consisting of corresponding one of the n parameters and corresponding one of the one or more evaluation values.

4. The device according to claim 2, wherein
the hardware processor is configured to repeat processing of:
acquiring the one or more evaluation values representing evaluation of the experiment or the simulation using the n recommended values every time the n recommended values are calculated;
adding a new data set including the acquired one or more evaluation values to the one or more data sets every time the one or more evaluation values are acquired, the new data set including the n recommended values as the n set values;
generating the estimation model every time the new data set is added to the one or more data sets; and
calculating the n recommended values based on the generated estimation model every time the estimation model is generated.

5. The device according to claim 4, wherein the hardware processor is configured to output the n recommended values selected from a plurality of values determined in advance or the n recommended values generated based on a rule determined in advance in a case in which the one or more data sets are not present.

6. The device according to claim 5, wherein the hardware processor is configured to output the n set values included in a data set with which the one or more evaluation values are best among the one or more data sets after repeating the processing until an end condition determined in advance is reached.

7. The device according to claim 2, wherein the estimation model is a model that takes monotonicity into account using information for identifying, for each of the n parameters, whether the target evaluation value of the one or more evaluation values monotonically increases as the target parameter increases, the target evaluation value monotonically decreases as the target parameter increases, or the target evaluation value does not monotonically increase or monotonically decrease with respect to the target parameter.

8. The device according to claim 7, wherein the estimation model is a Gaussian process regression model that takes monotonicity into account, and the estimation value is represented by an expression (101), and the estimated standard deviation is represented by an expression (102).
$${μ}_{n}^{f} ( x ) = {μ}_{0}^{f} ( x ) + ( \begin{matrix}K ( x , X ) & K ( x , {X}^{′} )\end{matrix} ) {( ( \begin{matrix}K ( X , X ) & K ( X , {X}^{′} ) \\ K ( {X}^{′} , X ) & K ( {X}^{′} , {X}^{′} )\end{matrix} ) + ( \begin{matrix}{σ}^{2} I & 0 \\ 0 & \tilde{Σ}\end{matrix} ) )}^{- 1} ( ( \begin{matrix}y \\ \tilde{μ}\end{matrix} ) - m ) \qquad ( 101 )$$
$${{σ}_{n}^{f} ( x )}^{2} = K ( x , x ) - ( \begin{matrix}K ( x , X ) & K ( x , {X}^{′} )\end{matrix} ) {( ( \begin{matrix}K ( X , X ) & K ( X , {X}^{′} ) \\ K ( {X}^{′} , X ) & K ( {X}^{′} , {X}^{′} )\end{matrix} ) + ( \begin{matrix}{σ}^{2} I & 0 \\ 0 & \tilde{Σ}\end{matrix} ) )}^{- 1} ( \begin{matrix}K ( X , x ) \\ K ( {X}^{′} , x )\end{matrix} ) \qquad ( 102 )$$

9. The device according to claim 7, wherein the hardware processor is configured to generate the estimation model by further using one or more pseudo data sets each including corresponding one of n values corresponding to n pseudo parameters and corresponding one of estimated partial differential values of the one or more evaluation values with respect to a d-dimensional parameter (d is from 1 through n, both inclusive) among the n parameters.

10. The device according to claim 7, wherein
the change direction information includes monotonicity information for each of the combinations each consisting of corresponding one of the n parameters and corresponding one of the one or more evaluation values, and
the monotonicity information indicates any of:
a monotonically increasing property representing that the target evaluation value monotonically increases as the target parameter increases;
a monotonically decreasing property representing that the target evaluation value monotonically decreases as the target parameter increases;
non-monotonicity representing that the target evaluation value does not monotonically increase or monotonically decrease with respect to the target parameter;
direction uncertainty representing that the target evaluation value monotonically increases or monotonically decreases with respect to the target parameter but it is uncertain which of monotonic increase and monotonic decrease is caused; and
monotonicity uncertainty representing that it is uncertain which of the monotonically increasing property, the monotonically decreasing property, and the non-monotonicity with respect to the target parameter the target evaluation value has.

11. The device according to claim 10, wherein
the hardware processor is configured to:
in a case in which the change direction information includes the monotonicity information indicating the monotonicity uncertainty or the direction uncertainty,
generate a plurality of pieces of assumed change direction information corresponding to all combination patterns or a portion of the all combination patterns obtained by replacing all pieces of the monotonicity information indicating the monotonicity uncertainty in the change direction information with the monotonically increasing property, the monotonically decreasing property, or the non-monotonicity, and replacing all pieces of the monotonicity information indicating the direction uncertainty with the monotonically increasing property or the monotonically decreasing property,
generate, for each of the plurality of pieces of assumed change direction information, the estimation model based on a corresponding piece of the assumed change direction information and the one or more data sets,
select an estimation model in which an estimation error is minimum or a length scale is maximum from among the estimation models each generated for corresponding one of the plurality of pieces of assumed change direction information, and
calculate the n recommended values based on the selected estimation model.

12. The device according to claim 11, wherein the hardware processor is configured to update the change direction information to be the assumed change direction information used for generating the selected estimation model.

13. The device according to claim 12, wherein the hardware processor is configured to update the change direction information in a case in which an estimation error is larger than a threshold determined in advance.

14. The device according to claim 12, wherein
the hardware processor is configured to:
calculate an estimated partial differential value for each of the one or more evaluation values with respect to a parameter corresponding to the monotonicity information indicating the monotonic increase or the monotonic decrease in the change direction information, based on the estimation model; and
update the change direction information in a case in which the monotonicity information indicating the monotonic increase or the monotonic decrease in the change direction information is different from a change direction of each of the one or more evaluation values identified by the estimated partial differential value for the corresponding parameter.

15. The device according to claim 10, wherein the hardware processor is configured to calculate the n recommended values based on the estimation model by using Bayesian optimization.

16. The device according to claim 15, wherein the hardware processor is configured to calculate the n recommended values that maximize a product of expected improvement and constraint satisfaction probability in the Bayesian optimization.

17. The device according to claim 15, wherein
the hardware processor is configured to:
select a best data set with which the one or more evaluation values are best from among the one or more data sets;
select a portion of the n parameters of the estimation model; and
fix values of the selected portion of the n parameters to corresponding values of the n set values included in the best data set, and calculate the n recommended values based on the estimation model.

18. The device according to claim 17, wherein
the hardware processor is configured to:
select the portion of the n parameters with which the monotonicity information does not indicate the monotonicity uncertainty or the direction uncertainty; and
fix values of the selected portion of the n parameters to corresponding values of the n set values included in the best data set, and calculate the n recommended values with which an acquisition function is maximum, based on the estimation model.

19. An information processing method comprising:
generating, by an information processing device, an estimation model based on one or more data sets and change direction information, the one or more data sets each including corresponding one of n set values (n is an integral number equal to or larger than 1) and corresponding one of one or more evaluation values representing evaluation of an experiment or a simulation performed by using the n set values; and
calculating, by the information processing device, n recommended values to be recommended as the n set values used for the experiment or the simulation based on the estimation model, wherein
the change direction information indicates a direction of a change of a target evaluation value among the one or more evaluation values with respect to a change of a target parameter among n parameters corresponding to the n set values for any one or more of combinations each consisting of corresponding one of the n parameters and corresponding one of the one or more evaluation values.

20. A computer program product comprising a computer-readable medium including programmed instructions, the instructions causing a computer of an information processing device to function as a processing unit configured to:
generate an estimation model based on one or more data sets and change direction information, the one or more data sets each including corresponding one of n set values (n is an integral number equal to or larger than 1) and corresponding one of one or more evaluation values representing evaluation of an experiment or a simulation performed by using the n set values; and
calculate n recommended values to be recommended as the n set values used for the experiment or the simulation based on the estimation model, wherein
the change direction information indicates a direction of a change of a target evaluation value among the one or more evaluation values with respect to a change of a target parameter among n parameters corresponding to the n set values for any one or more of combinations each consisting of corresponding one of the n parameters and corresponding one of the one or more evaluation values.
